(19) United States
(12) Patent Application Publication
(10) Pub. No.: US 2006/0191249 A1
(43) Pub. Date: Aug. 31, 2006

(54) Electronic enclosure filter containing polymer microfiber element

(76) Inventors: Mark A. Gogins, Roseville, MN (US); Katsushi Isogawa, Eagan, MN (US); Kristine M. Graham, Minnetonka, MN (US)

Correspondence Address: PAULY, DEVRIES SMITH & DEFFNER, L.L.C., 900 IDS CENTER, 80 SOUTH EIGHTH STREET, MINNEAPOLIS, MN, 55402-8773, US

(21) Appl. No.: 11/270,311

(22) Filed: Nov. 9, 2005

Related U.S. Application Data
(60) Provisional application No. 60/626,824, filed on Nov. 9, 2004.

(51) Int. Cl. B01D 39/16

(52) U.S. Cl. 55/528

(57) ABSTRACT

The present invention is directed to a filter assembly for use inside an electronic enclosure, such as a hard disk drive enclosure containing a rotating disk. The filter assembly provides filtration of air within the electronic enclosure, and optionally for air entering the electronic enclosure. Thus, the invention is directed in part to a filter assembly for use in an electronic enclosure, the filter assembly comprising particulate removal media. In certain embodiments the particulate removal media comprising a fine fiber layer containing a hydrophobic additive and at least one polymer. In some implementations it includes a blend of two or more polymers.

### PRIORITY

This application claims the benefit of U.S. Provisional Patent Application Ser. No. 60/626,824, filed Nov. 9, 2004, which application is hereby incorporated by reference in its entirety.

### BACKGROUND OF THE INVENTION

Hard disk drives are enclosures in which an inflexible platter coated with magnetic material is rapidly spun. A magnetic read/write head “flies” only a few microns above the disk on an air cushion. It is desirable to position the head as close to the disk as possible without touching it in order to provide a hard disk drive having high efficiency.

It has been found that particulate and gaseous contaminants act to reduce efficiency and longevity of hard disk drives. Common sources of contaminants in disk drives include leaks, which may or may not be intentional; the manufacturing environment, which can contain certain contaminants; and the materials incorporated into the disk drives which give off particulates and gases.

Recirculation filters have been used in hard disk drives and other electronic enclosures for removing contaminants, and such filters have been effective for removing particulate contaminants. Some recirculation filters have included electrostatic media designed to collect and retain particulate contamination. However, at elevated temperatures experienced by some disk drives, this electrostatic media can degrade. These problems can be particularly significant for disk drives that will be exposed to environments with elevated temperatures, such as disk drives installed in automobiles or mobile devices.

Thus, a need exists for improved recirculation filters, and improved filter media, for use in electronic enclosures.

### SUMMARY OF THE INVENTION

The present invention is directed to a filter assembly for use inside an electronic enclosure, such as a hard disk drive enclosure containing a rotating disk. The filter assembly provides filtration of air within the electronic enclosure, and optionally for air entering the electronic enclosure.

Thus, the invention is directed in part to a filter assembly for use in an electronic enclosure, the filter assembly comprising particulate removal media. In certain embodiments the particulate removal media comprising a fine fiber layer containing a hydrophobic additive and at least one polymer. In some implementations it includes a blend of two or more polymers.

In some implementations the fine fiber layer comprises fibers formed of a blend of two polymer resins, and the fibers have a diameter of 0.01 to 0.5 micron. Suitable fine fiber layers can be made of varying thicknesses, including layers with a thickness of less than about 30 microns. Such thin layers are possible due to the high efficiency of the fine fiber at capturing particles, and allows for efficient particulate capture with reduced resistance to airflow compared to various prior filter media. In some implementations the fine fiber layer has a thickness of less than about 20 microns.

In addition to the particulate filter media, the filter assembly can contain an adsorbent material. Suitable adsorbent material includes, for example, activated carbon. Filter media further can also include a woven or non-woven substrate. Suitable substrates include glass, polymer, metal, and combinations thereof.

In some embodiments the filter media shows excellent durability in challenging environments of high temperature and humidity. For example, in certain embodiments the fine fiber media, when exposed to an air stream having a temperature of about 140° F. and a relative humidity of about 100%, greater than about 50% of the fiber survives for more than 16 hours. Such conditions, particularly the high humidity, are unlikely to be experienced in a normal electronic enclosure containing a disk drive. However, durability under such extreme conditions is advantageous because it also indicates durability at the less extreme conditions within disk drives, where even relatively modest degradation of the particulate filter media can be detrimental to functioning of the drive.

Specific implementations of the invention are directed to a filter assembly for use in an electronic enclosure, the filter assembly comprising particulate removal media containing a fine fiber layer and a substrate layer having a basis weight of about 8 to 200 grams/meter². The fine fiber can comprise a blend of a hydrophobic additive and a polymer comprising a blend of at least two different polymers, the fine fiber having a fiber size of about 0.01 to 0.5 micron. In some embodiments, after exposure to air at 140° F. and 100% relative humidity for 1 to 16 hours, at least 50% of the fine fiber remains substantially unchanged. In certain implementations the fine fiber layer comprises a blend of a hydrophobic additive and a polymer comprising a acrylic polymers. The fine fiber layer can be formed, for example, from the reaction product of a polymer resin and a cross linking agent.

The above summary of the present invention is not intended to describe each discussed embodiment of the present invention. This is the purpose of the figures and the detailed description that follows.

### DRAWINGS

The invention may be more completely understood in connection with the following drawings, in which:

FIG. 1 is a perspective view of a basic filter assembly constructed and arranged in accordance with the invention.

FIG. 2 is a cross-sectional view of the filter assembly of FIG. 1, taken along lines A-A′ of FIG. 1.

FIG. 3 is a cross-sectional view of a multilayer filter assembly made in accordance with the invention, the filter assembly including an adsorbent material.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The present invention provides a filter assembly containing improved filter media for use in electronic enclosures to remove particulate contamination. This filter media has improved physical and chemical stability, making it well suited for use in electronic enclosures expected to operate at elevated temperatures.

The present invention is also directed to a filter construction for placement within a disk drive enclosure. The filter construction can be configured to remove physical contaminants, e.g., particulates, from either or both of the air within the enclosure and the air entering the enclosure. As operating temperatures increase, the efficiency of the electrostatic media is diminished. The media of the present invention provides mechanical filtration that is less affected at temperatures well above new high temperature estimates for operation in new disk drive applications. The filter media of the present invention can also offer better efficiency when attempting to remove smaller particles. This improved efficiency has become increasingly important as the “fly-height” of the disk drive read-write head above the disk has decreased.

The present invention is also directed to a disk drive assembly having a filter construction therein. Such a disk drive assembly comprises an enclosure, a disk rotatably mounted within the enclosure, and a filter construction. The filter construction, which is positioned within the enclosure, comprises a housing positioned in an air current, the air current moving within the disk drive enclosure; and a first filter portion in the housing.

Referring now to the figures, an embodiment of the invention is described in detail with reference to the drawings, wherein like reference numbers represent like parts and assemblies throughout the several views. The terms “adsorb”, “adsorbing”, “adsorbent”, and the like are to be understood to encompass both adsorption and absorption phenomena and materials. Although other fluids may be filtered by the filter assembly, the filtration of contaminants from air will be used as an illustration.

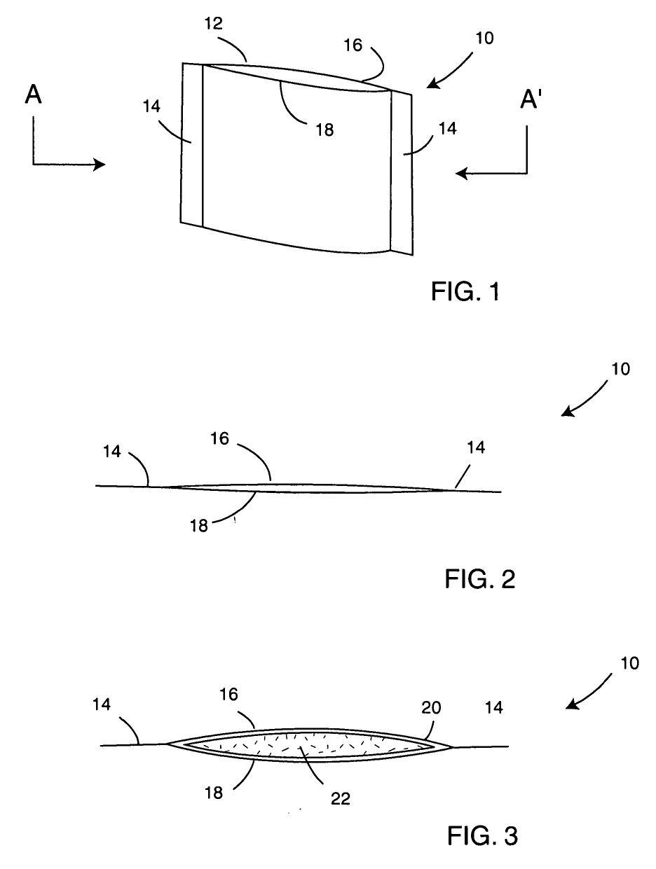

Referring to FIG. 1, a perspective view is shown of a filter assembly 10 constructed in accordance with the present invention. Filter assembly 10 includes a recirculation filter element 12. Recirculation filter element 12 having edge portions 14 configured to be secured to a frame or other mounting arrangement, such that filter element allows the flow of air through the interior of the element. The outer surfaces 16, 18 of filter element 12 contain filter media particularly well suited for capture of small particles.

FIG. 2 shows a cross section of filter assembly 10 taken along lines A-A′ of FIG. 1. Specifically, FIG. 3 shows the entire cross section of the filter assembly 10. In the embodiment shown in FIG. 3, an interior 20 of the filter assembly further includes adsorbent material 22, such as activated carbon.

The filtration assembly can also have additional layers or fewer layers, as desired, and the layers can be different on the top and bottom. For example, the filtration assembly can be limited to an adsorbent material having a particulate absorptive layer on one side only, with an additional layer on the opposite side that prevents escape of the adsorbent material without substantially removing particulates.

Additional description of the materials used to form the filter assembly of the invention will now be provided.

Particulate Removal Layer

Each filtration assembly 10 contains at least one particulate removal or filtration layer. Suitable materials include those disclosed in U.S. Pat. No. 6,743,273, herein incorporated by reference in its entirety. The filter media as disclosed herein have substantially improved resistance to the undesirable effects of heat, humidity, high flow rates, submicron particulates, and other demanding conditions. The improved microfiber and nanofiber performance is a result of the improved character of the polymeric materials forming the microfiber or nanofiber.

Further, the filter media 18 of the invention using the improved polymeric materials of the invention provides a number of advantageous features including higher efficiency, lower flow restriction, high durability (stress related or environmentally related) in the presence of abrasive particulates and a smooth outer surface free of loose fibers or fibrils. The overall structure of the filter media provides an overall thinner media allowing improved media area per unit volume, improved media efficiency and reduced flow restrictions.

Filter media useful for electronic enclosures can include microfiber and nanofiber compositions. Nanofiber is a fiber with diameter less than 200 nanometer or 0.2 micron. Microfiber is a fiber with diameter larger than 0.2 micron, but not larger than 10 microns. This filter media can be made in the form of an improved multi-layer microfiltration media structure of fine fiber layers. The fine fiber layers of the invention can comprise a random distribution of fine fibers that can be bonded to form an interlocking net. Filtration performance is obtained largely as a result of the fine fiber barrier to the passage of particulates.

Structural properties of stiffness, strength, pleatability of the fiber used in the filter media of the filter assemblies can be provided by the substrate to which the fine fiber is adhered. The fine fiber interlocking networks have, as important characteristics, fine fibers in the form of microfibers or nanofibers and relatively small spaces between the fibers. Such spaces typically range, between fibers, of about 0.01 to about 25 microns or often about 0.1 to about 10 microns.

One desirable fine fiber filter media of the invention is a polymer blend comprising a first polymer and a second different polymer (differing in polymer type, molecular weight or physical property) that is conditioned or treated at elevated temperature. The polymer blend can be reacted and formed into a single chemical specie or can be physically combined into a blended composition by an annealing process. Annealing implies a physical change, like crystallinity, stress relaxation or orientation. Preferred materials are chemically reacted into a single polymeric specie such that a differential scanning calorimeter analysis reveals a single polymeric material. Such a material, when combined with a preferred additive material, can form a surface coating of the additive on the microfiber that provides oleophobicity, hydrophobicity or other associated improved stability when contacted with high temperature, high humidity and difficult operating conditions.

The filter material fine fiber of the class of materials can have a diameter of 2 microns to less than 0.01 micron. Such microfibers can have a smooth surface comprising a discrete layer of the additive material or an outer coating of the additive material that is partly solubilized or alloyed in the polymer surface, or both.

Suitable materials for use in the blended polymeric systems include nylon 6; nylon 66; nylon 6-10; nylon 6-66-610 copolymers and other linear generally aliphatic nylon compositions. A desiarable nylon copolymer resin (SVP-651) was analyzed for molecular weight by the end group titration. (J. E. Walz and G. B. Taylor, determination of the molecular weight of nylon, Anal. Chem. Vol. 19, Number 7, pp 448-450 (1947). A number average molecular weight (Wₙ) was between 21,500 and 24,800. The composition was estimated by the phase diagram of melt temperature of three component nylon, nylon 6 about 45%, nylon 66 about 20% and nylon 610 about 25%. (Page 286, Nylon Plastics Handbook, Melvin Kohan ed. Hanser Publisher, New York (1995)).

A polyvinylalcohol having a hydrolysis degree of from 87 to 99.9+% can be used in production of the filter media using these polymer systems. These are optionally cross linked, such as being crosslinked and combined with substantial quantities of the oleophobic and hydrophobic additive materials.

Another desirable mode of the invention involves a single polymeric material combined with an additive composition to improve fiber lifetime or operational properties. The preferred polymers useful in this aspect of the invention include nylon polymers, polyvinylidene chloride polymers, polyvinylidene fluoride polymers, polyvinylalcohol polymers and, in particular, those listed materials when combined with strongly oleophobic and hydrophobic additives that can result in a microfiber or nanofiber with the additive materials formed in a coating on the fine fiber surface. Again, blends of similar polymers such as a blend of similar nylons, similar polyvinylchloride polymers, blends of polyvinylidene chloride polymers are useful in this invention.

Further, polymeric blends or alloys of differing polymers are also contemplated for use as filter media in electronic enclosures. In this regard, compatible mixtures of polymers are useful in forming the microfiber materials. Additive composition such a fluoro-surfactant, a nonionic surfactant, low molecular weight resins, such as tertiary butylphenol resin having a molecular weight of less than about 3000 can be used. The resin is characterized by oligomeric bonding between phenol nuclei in the absence of methylene bridging groups. The positions of the hydroxyl and the tertiary butyl group can be randomly positioned around the rings. Bonding between phenolic nuclei occurs next to a hydroxyl group rather than randomly. Similarly, the polymeric material can be combined with an alcohol soluble non-linear polymerized resin formed from bis-phenol A. Such material is similar to the tertiary butylphenol resin described above in that it is formed using oligomeric bonds that directly connect aromatic ring to aromatic ring in the absence of any bridging groups such as alkylene or methylene groups.

A particularly filter material of the invention comprises a microfiber material having a dimension of about 2 to 0.01 microns. One particular desirable fiber size range is between 0.05 to 0.5 micron. Such fibers provide excellent filter activity, ease of back pulse cleaning and other aspects.

One important parameter of the filter elements after formation is its resistance to the effects of heat, humidity or both. One aspect of the filter media of the invention is a test of the ability of the filter media to survive immersion in warm water for a significant period of time. The immersion test can provide valuable information regarding the ability of the fine fiber to survive hot humid conditions.

Another suitable filter material with a fine fiber filter structure includes a bi-layer or multi-layer structure wherein the filter contains one or more fine fiber layers combined with or separated by one or more synthetic, cellulosic or blended webs. Another optional motif is a structure including fine fiber in a matrix or blend of other fibers.

We believe important characteristics of the fiber and microfiber layers in the filter structure relate to temperature resistance, humidity or moisture resistance and solvent resistance, particularly when the microfiber is contacted with humidity, moisture or a solvent at elevated temperatures. Further, a second important property of the materials of the invention relates to the adhesion of the material to a substrate structure. The microfiber layer adhesion is an important characteristic of the filter material such that the material can be manufactured without delaminating the microfiber layer from the substrate, the microfiber layer plus substrate can be processed into a filter structure including pleats, rolled materials and other structures without significant delamination.

We have found that the heating step of the manufacturing process wherein the temperature is raised to a temperature at or near but just below melt temperature of one polymer material, typically lower than the lowest melt temperature substantially improves the adhesion of the fibers to each other and the substrate. At or above the melt temperature, the fine fiber can lose its fibrous structure. It is also critical to control heating rate. If the fiber is exposed to its crystallization temperature for extended period of time, it is also possible to lose fibrous structure. Careful heat treatment also improved polymer properties that result from the formation of the exterior additive layers as additive materials migrate to the surface and expose hydrophobic or oleophobic groups on the fiber surface.

The criteria for performance is that the material be capable of surviving intact various operating temperatures, i.e. a temperature of 140° F., 160° F., 270° F., 300° F. for a period of time of 1 hour or 3 hours, depending on end use, while retaining 30%, 50%, 80% or 90% of filter efficiency. An alternative criteria for performances that the material is capable of surviving intact at various operating temperatures, i.e. temperatures of 140° F., 160° F., 270° F., 300° F., for a period of time of 1 hours or 3 hours depending on end use, while retaining, depending on end use, 30%, 50%, 80% or 90% of effective fine fibers in a filter layer. Survival at these temperatures is important at low humidity, high humidity, and in water saturated air. The microfiber and filter material of the invention are deemed moisture resistant where the material can survive immersion at a temperature of greater than 160° F. while maintaining efficiency for a time greater than about 5 minutes. Similarly, solvent resistance in the microfiber material and the filter material of the invention is obtained from a material that can survive contact with a solvent such as ethanol, a hydrocarbon, a hydraulic fluid, or an aromatic solvent for a period of time greater than about 5 minutes at 70° F. while maintaining 50% efficiency.

The fine fibers that comprise the micro- or nanofiber containing layer of the invention can be fiber and can have a diameter of about 0.001 to 2 micron, preferably 0.05 to 0.5 micron. The thickness of the typical fine fiber filtration layer ranges from about 1 to 100 times the fiber diameter with a basis weight ranging from about 0.01 to 240 micrograms-cm⁻².

Polymeric materials have been fabricated in non-woven and woven fabrics, fibers and microfibers. The polymeric material provides the physical properties required for product stability. These materials should not change significantly in dimension, suffer reduced molecular weight, become less flexible or subject to stress cracking or physically deteriorate in the presence of sunlight, humidity, high temperatures or other negative environmental effects. The invention relates to an improved polymeric material that can maintain physical properties in the face of incident electromagnetic radiation such as environmental light, heat, humidity and other physical challenges.

Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Preferred addition polymers tend to be glassy (a Tg greater than room temperature). This is the case for polyvinylchloride and polymethylmethacrylate, polystyrene polymer compositions or alloys or low in crystallinity for polyvinylidene fluoride and polyvinylalcohol materials.

One class of polyamide condensation polymers are nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Another nylon can be made by the polycondensation of epsilon caprolactam in the presence of a small amount of water. This reaction forms a nylon-6 (made from a cyclic lactam—also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C₁₀ blend of diacids. A nylon 6-6,6-6,10 is a nylon manufactured by copolymerization of epsilonaminocaproic acid, hexamethylene diamine and a blend of a C₆ and a C₁₀ diacid material.

Block copolymers are also useful in the process of this invention. With such copolymers the choice of solvent swelling agent is important. The selected solvent is such that both blocks were soluble in the solvent. One example is a ABA (styrene-EP-styrene) or AB (styrene-EP) polymer in methylene chloride solvent. If one component is not soluble in the solvent, it will form a gel. Examples of such block copolymers are Kraton® type of styrene-b-butadiene and styrene-b-hydrogenated butadiene(ethylene propylene), Pebax® type of e-caprolactam-b-ethylene oxide, Sympatex® polyester-b-ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, can be solution spun with relative ease because they are soluble at low pressures and temperatures. However, highly crystalline polymer like polyethylene and polypropylene require high temperature, high pressure solvent if they are to be solution spun. Therefore, solution spinning of the polyethylene and polypropylene is very difficult. Electrostatic solution spinning is one method of making nanofibers and microfiber.

Chemical Absorptive Element

In some embodiments at least one portion of the filter assembly includes an adsorptive element, typically a chemical adsorptive material containing carbon. Thus, at least a portion of the material used in the multilayer filtration article has adsorbent properties. The adsorbent material can include physisorbents and/or chemisorbents, such as desiccants (i.e., materials that adsorb or absorb water or water vapor) and/or materials that adsorb volatile organic compounds and/or acid gas. Acid gases can be generated inside an electronic enclosure, thus it is desirable to include an organic vapor removal layer impregnated with a chemical which provides enhanced acid gas removal. Exemplary chemicals which can be used to evaluate an impregnants ability to remove acid gas include hydrogen sulfide (H₂S), hydrochloric acid (HCl), chlorine gas (Cl₂), and the like.

Suitable adsorptive materials include, for example, activated carbon, activated alumina, molecular sieves, silica gel, potassium permanganate, calcium carbonate, potassium carbonate, sodium carbonate, calcium sulfate, or mixtures thereof. The adsorbent material may adsorb one or more types of contaminants, including, for example, water, water vapor, acid gas, and volatile organic compounds. Although the adsorbent material may be a single material, mixtures of materials are also useful. For typical operation, an adsorbent material that is stable and adsorbs within a temperature range of −40° C. to 100° C. is preferred. Carbon is suitable for most implementations, and carbon suitable for use with the present invention is disclosed in U.S. Pat. No. 6,077,335, incorporated herein by reference in its entirety.

The adsorbent material can be provided in the form of a granular material, a tablet, a sheet, or other suitable form. In certain embodiments the adsorbent material is a powder that is bound together. In such implementations the adsorbent material can be a powder (passes through 100 mesh) or granular material (28 to 200 mesh) prior to forming into a shaped adsorbent article. The binder is typically dry, powdered, and/or granular and can be mixed with the adsorbent. In some embodiments, the binder and adsorbent material are mixed using a temporary liquid binder and then dried. Suitable binders include, for example, microcrystalline cellulose, polyvinyl alcohol, starch, carboxyl methyl cellulose, polyvinylpyrrolidone, dicalcium phosphate dihydrate, and sodium silicate.

It will be appreciated that, although the implementation of the invention described above is directed to a hard drive enclosure, the present device may be used with other electronic enclosures, and is not limited to hard drive enclosures. In addition, while the present invention has been described with reference to several particular implementations, those skilled in the art will recognize that many changes may be made hereto without departing from the spirit and scope of the present invention.

We claim:

1. A filter assembly for use in an electronic enclosure, the filter assembly comprising particulate removal media comprising a fine fiber layer comprising a blend of a hydrophobic additive and a polymer comprising at least one polymer.

2. The filter assembly for use in an electronic enclosure of claim 1, wherein the fine fiber layer comprises fibers formed of a blend of two polymer resins and have a diameter of 0.01 to 0.5 micron.

3. The filter assembly for use in an electronic enclosure of claim 1, wherein the fine fiber layer comprises a blend of at least two polymers.

4. The filter assembly for use in an electronic enclosure of claim 1, wherein the fine fiber layer has a thickness of less than about 20 microns.

5. The filter assembly for use in an electronic enclosure of claim 1, further comprising an adsorbent material.

6. The filter assembly for use in an electronic enclosure of claim 1, wherein the fine fiber layer, when exposed to an air stream having a temperature of about 140° F. and a relative humidity of about 100%, greater than about 50% of the fiber survives for more than 16 hours.

7. The filter assembly for use in an electronic enclosure of claim 1, wherein the filter media further comprises a woven or non-woven substrate.

8. The filter assembly for use in an electronic enclosure of claim 7, wherein the non-woven substrate comprises a fiber selected from glass, polymer, metal, and combinations thereof.

9. A filter assembly for use in an electronic enclosure, the filter assembly comprising particulate removal media comprising a fine fiber layer and a substrate layer having a basis weight of about 8 to 200 grams/meter², the fine fiber comprising a blend of a hydrophobic additive and a polymer comprising a blend of at least two different polymers, the fine fiber having a fiber size of about 0.01 to 0.5 micron, the substrate comprising a filtration media; wherein after exposure to air at 140° F. and 100% relative humidity for 1 to 16 hours, at least 50% of the fine fiber remains substantially unchanged.

10. The filter assembly for use in an electronic enclosure of claim 9, wherein the fine fiber layer comprises a blend of a hydrophobic additive and a polymer comprising a acrylic polymers.

11. The filter assembly for use in an electronic enclosure of claim 9, wherein the fine fiber layer comprises the reaction product of a polymer resin and a cross linking agent.

12. The filter assembly for use in an electronic enclosure of claim 9, wherein the fine fiber layer comprises a blend of two polymer resins and has a diameter of 0.01 to 0.2 micron.

13. The filter assembly for use in an electronic enclosure of claim 9, wherein the filter assembly further includes an adsorbent material.

14. The filter assembly for use in an electronic enclosure of claim 9, wherein the filter media further comprises a woven or non-woven substrate.

15. A multilayer filter assembly for use in an electronic enclosure, the filter assembly comprising:
a first filtering portion configured and arranged for placement over an opening in the electronic enclosure; the first filtering portion including an adhesive layer for securing the first filtering portion over the opening; and
a second filtering portion configured and arranged for filtering air circulating in the electronic enclosure;
wherein at least the first or second filtering portion comprises a fine fiber layer comprising a blend of a hydrophobic additive and a polymer comprising a blend of at least two different polymers.

16. The filter assembly for use in an electronic enclosure of claim 15, wherein the fine fiber layer comprises fibers formed of a blend of two polymer resins and have a diameter of 0.01 to 0.5 micron.

17. The filter assembly for use in an electronic enclosure of claim 15, wherein the fine fiber layer has a thickness of less than about 30 microns.

18. The filter assembly for use in an electronic enclosure of claim 15, wherein the fine fiber layer has a thickness of less than about 20 microns.

19. The filter assembly for use in an electronic enclosure of claim 15, further comprising an adsorbent material.

20. The filter assembly for use in an electronic enclosure of claim 15, wherein the fine fiber layer, when exposed to an air stream having a temperature of about 140° F. and a relative humidity of about 100%, greater than about 50% of the fiber survives for more than 16 hours.
